(19) United States
(12) Patent Application Publication
(10) Pub. No.: US 2010/0183275 A1
(43) Pub. Date: Jul. 22, 2010

(54) CARRIER SYSTEM FOR A DISTRIBUTING DEVICE FOR OPTICAL WAVEGUIDES

(75) Inventors: Ulrich Hetzer, Berlin (DE); Frank Mossner, Berlin (DE); Ferenc Nad, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/528,705

(22) PCT Filed: Feb. 15, 2008
(86) PCT No.: PCT/EP2008/001153

§ 371 Date: Mar. 26, 2010

(30) Foreign Application Priority Data
Mar. 1, 2007 (DE) 10 2007 010 855.0

(51) Int. Cl. G02B 6/00

(52) U.S. Cl. 385/135

(57) ABSTRACT

The invention relates to a carrier system (5) for a distribution device for optical waveguides for accommodating components for optical waveguides, in particular for accommodating splicing cassettes (80), the carrier system (5) comprising a central carrier (71), on whose sides in each case one profiled carrier (72) is arranged, the profiled carriers (72) having profiles for accommodating the components on the front side and/or rear side (V, R).

The invention relates to a carrier system for a distribution device for optical waveguides.

The main object of carrier systems in distribution devices for optical waveguides is to hold components for optical waveguides such as splicing cassettes, for example, in a defined manner. For this purpose, it is known to provide two round bars, which are arranged at a defined distance from one another, it being possible for the splicing cassettes to be pushed onto the two round bars from above through corresponding openings in the housing of the splicing cassettes and stacked. The distribution device can in this case be, for example, a sleeve, a cable splitter or a sealing end.

The invention is based on the technical problem of providing a carrier system which has a simple design and nevertheless allows for a diverse use of the carrier system.

The technical problem is solved by the subject matters having the features of claim 1. Further advantageous configurations of the invention are given in the dependent claims.

In this regard, the carrier system for a distribution device for optical waveguides for accommodating components for optical waveguides, in particular for accommodating splicing cassettes, comprises a central carrier, on whose sides in each case one profiled carrier is arranged, the profiled carrier having profiles for accommodating the components on the front and/or the rear side. This makes a modular design of the carrier system possible, with the result that, for example, profiled carriers having different lengths and/or different profiles can be used, if necessary.

The central carrier is in this case preferably in the form of a planar plate and further preferably is connected detachably to the profiled carriers.

In a preferred embodiment, the profiled carriers have a region, which is initially in the form of a V, on the outwardly pointing sides, then limbs running parallel and having inwardly pointing bent-back portions. This makes it possible to fix further units, such as bundle core guides and/or fibre guides, for example, to the carrier system.

In a further preferred embodiment, the profiled carriers have a U-shaped region on the inwardly pointing sides. By means of this U-shaped region, the profiled carrier can be pushed laterally onto the central carrier and screwed to it, the two limbs of the U-shaped region resting on the front side and rear side of the central carrier, and the base of the U-shaped region resting on the side face of the central carrier. Furthermore, the two spaced-apart U-shaped regions form an insertion region from the upper side.

In a further preferred embodiment, a plate-shaped region is arranged between the V-shaped region and the U-shaped region, by means of which plate-shaped region the V-shaped region can be displaced further outwards in order to have sufficient space when fitting the elements fixed to the V-shaped region.

In a further preferred embodiment, the profiled carriers are a multiple longer than the central carrier, further preferably transverse carriers for reinforcing purposes being arranged between the profiled carriers.

In a further preferred embodiment, the central carrier has at least one hole. The central carrier can be screwed to a console and/or a fibre management unit and/or the profiled carriers via the holes.

The invention will be explained in more detail below with reference to a preferred exemplary embodiment. In the figures:

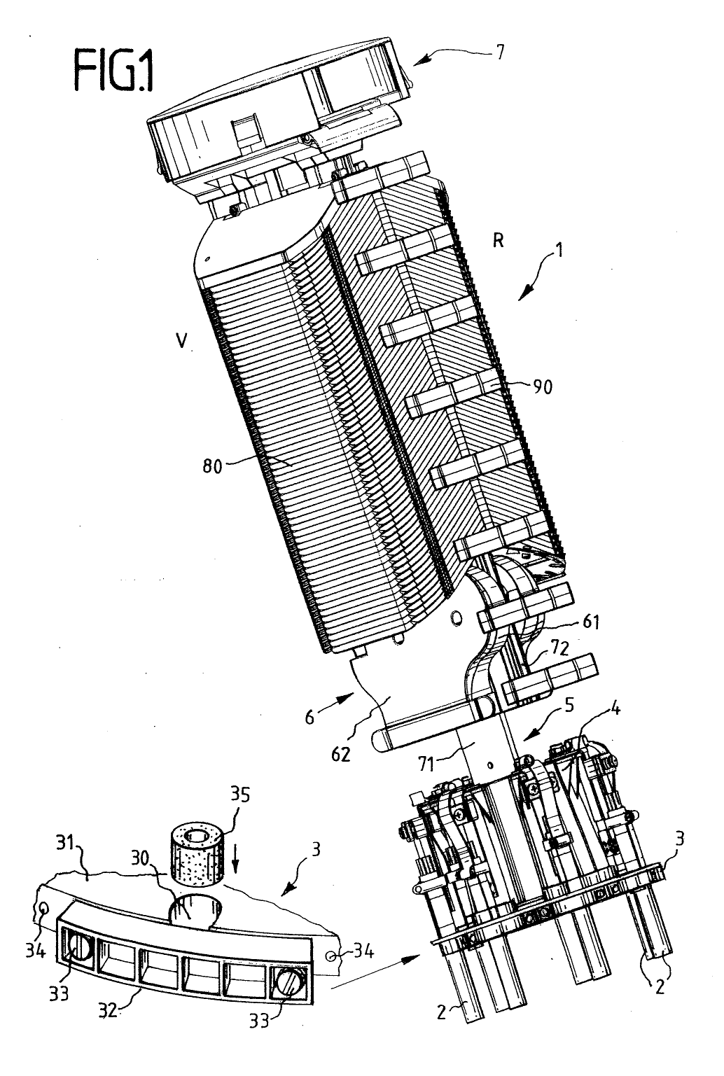

FIG. 1 shows a perspective front view of a sleeve for optical waveguide cables without a housing upper part,

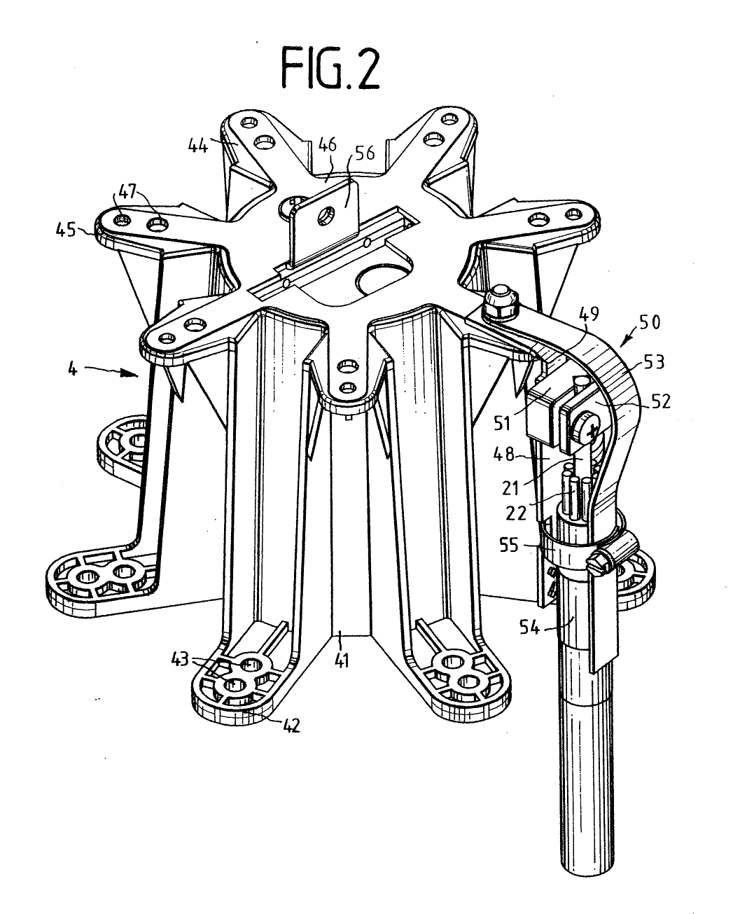

FIG. 2 shows a perspective illustration of a console with a ground plate,

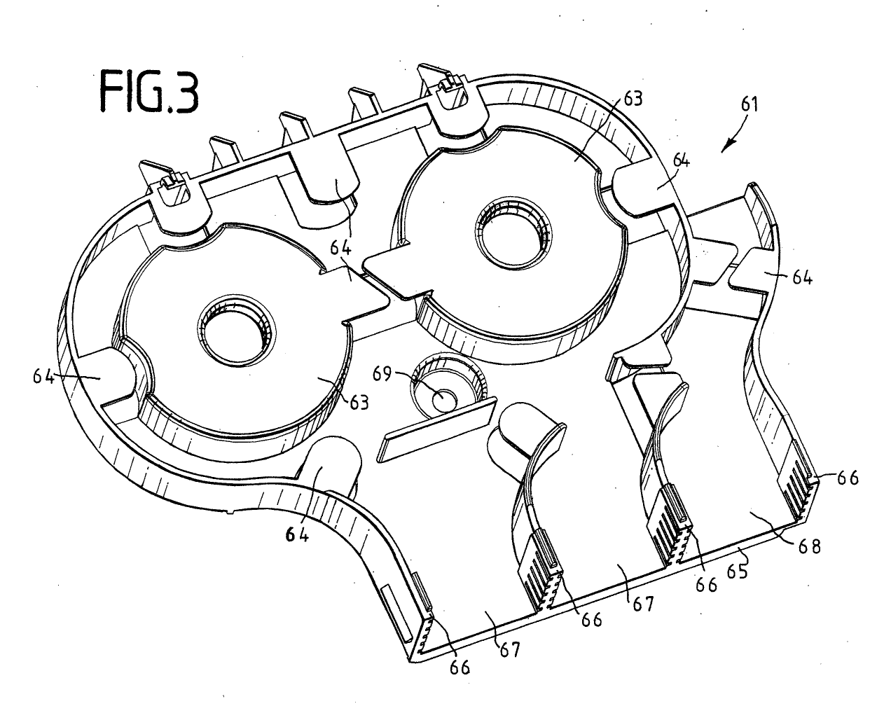

FIG. 3 shows a perspective front view of a part of the fiber management unit,

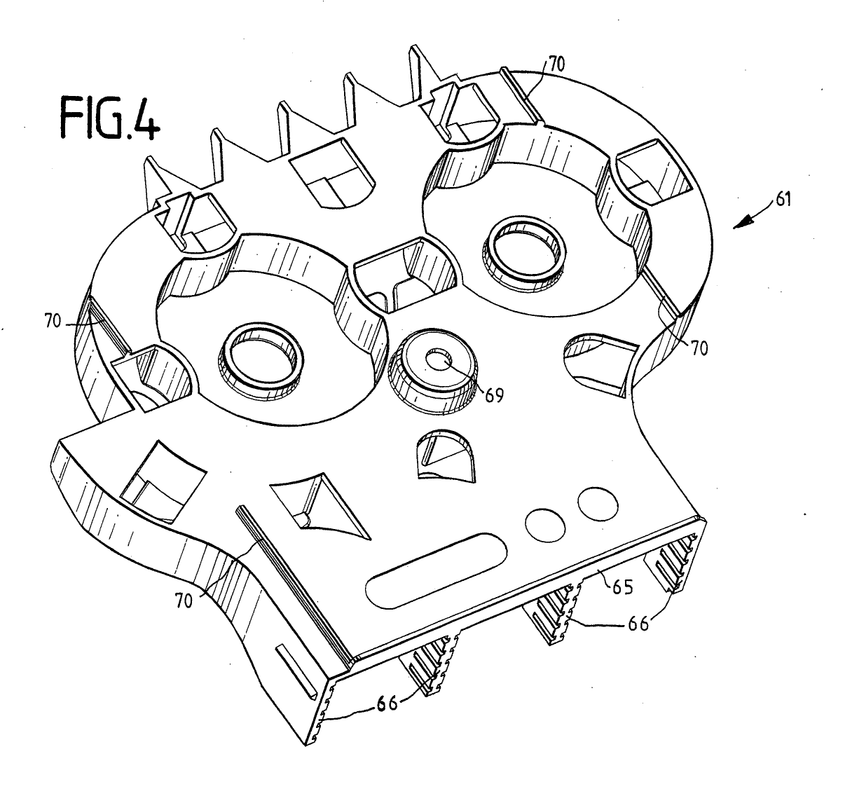

FIG. 4 shows a perspective rear view of the part shown in FIG. 3,

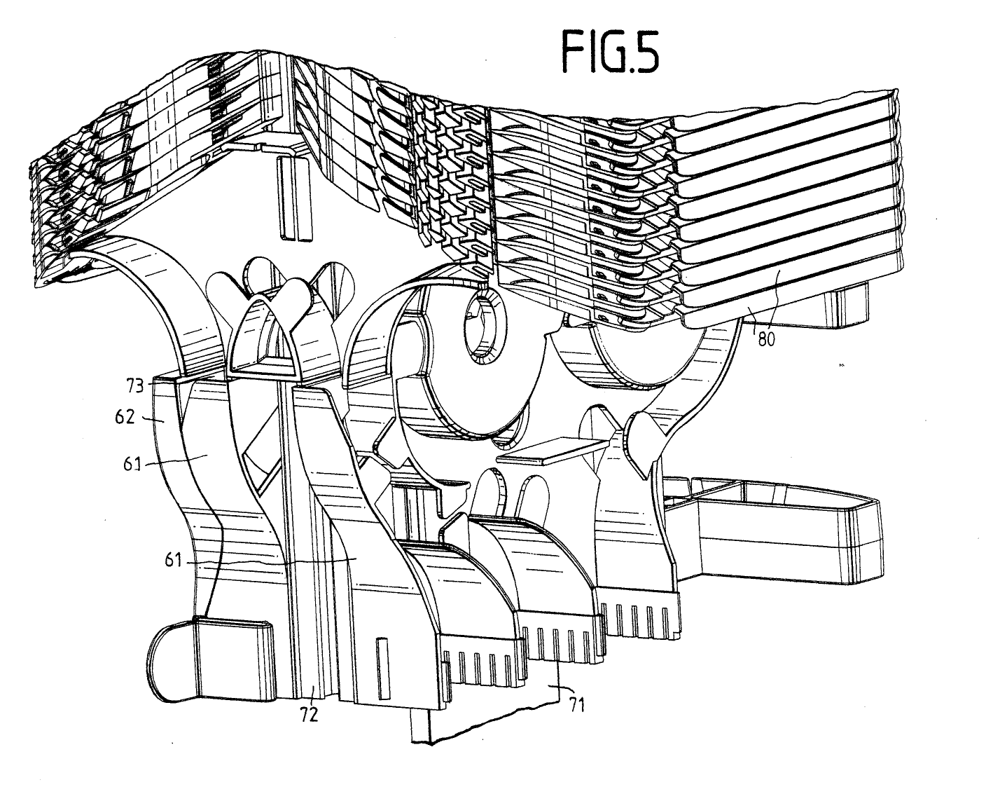

FIG. 5 shows a perspective side view of the fiber management unit,

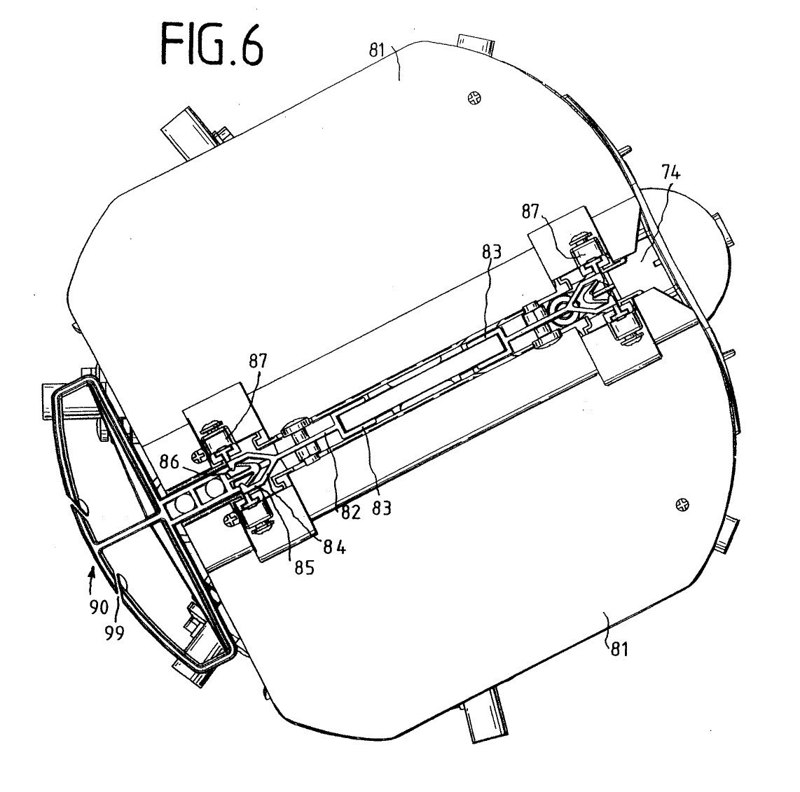

FIG. 6 shows a plan view of the sleeve with the bundle core repository removed,

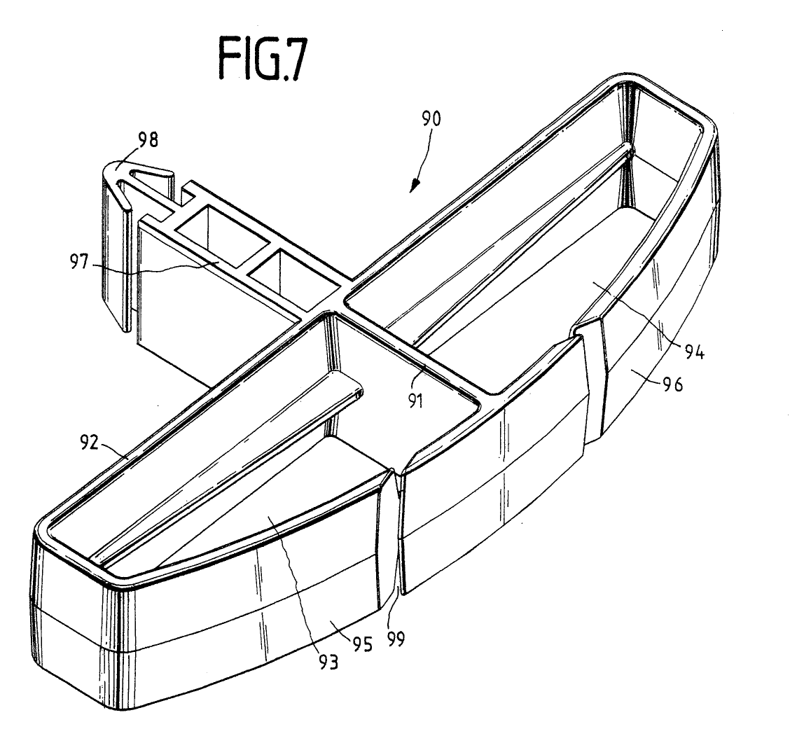

FIG. 7 shows a perspective illustration of a bundle core guide,

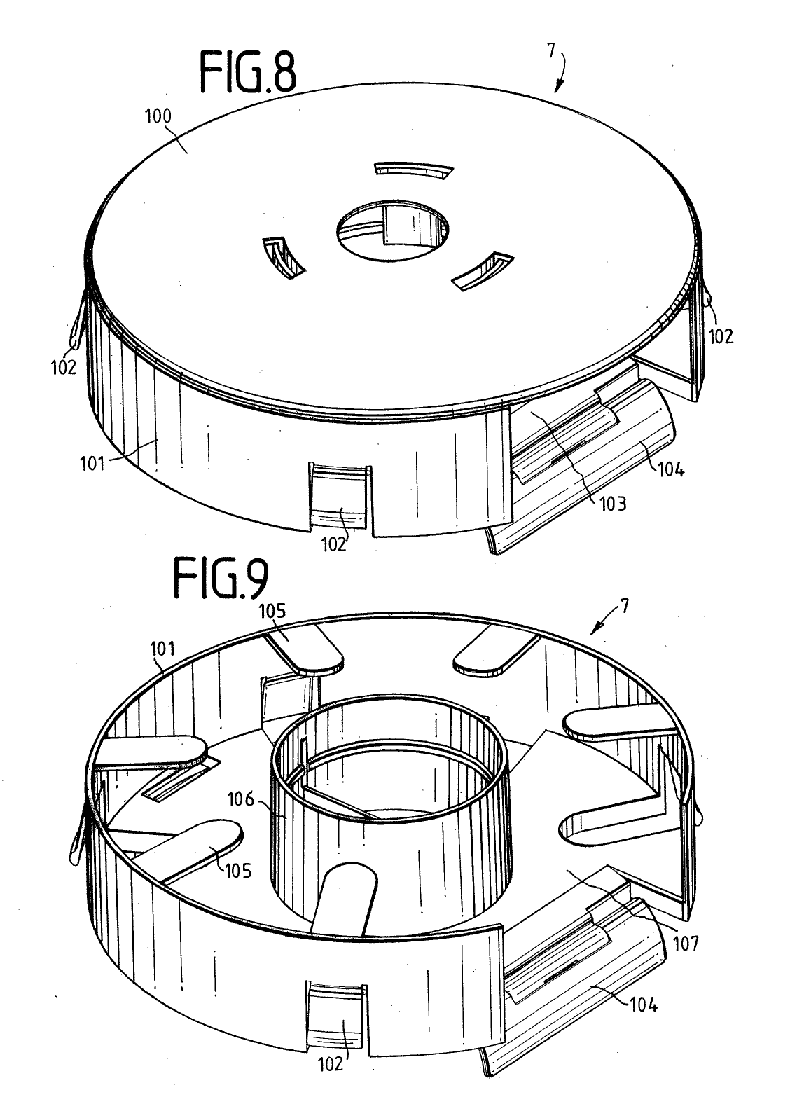

FIG. 8 shows a perspective illustration of a bundle core repository,

FIG. 9 shows a perspective illustration of the bundle core repository without the cover,

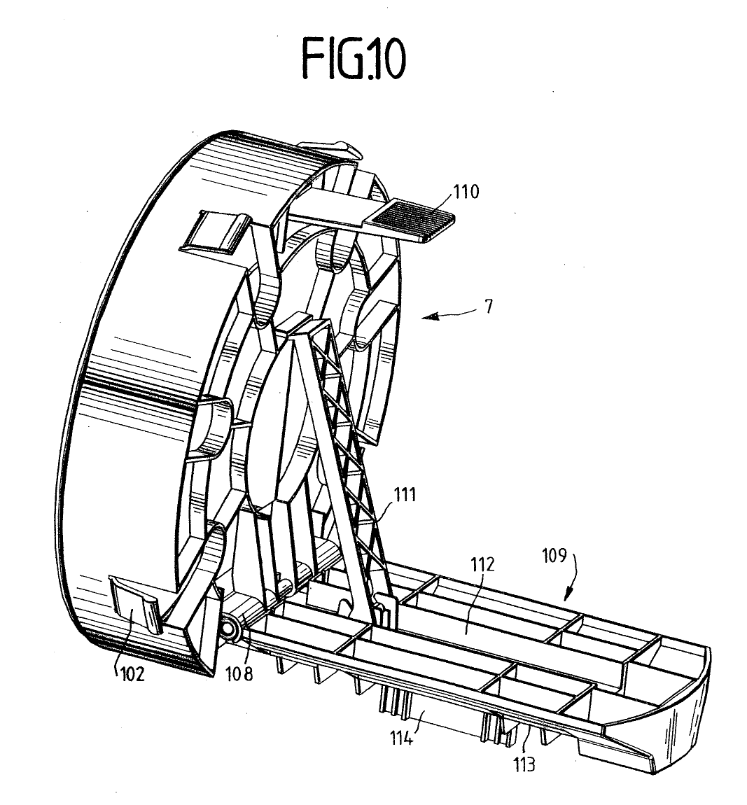

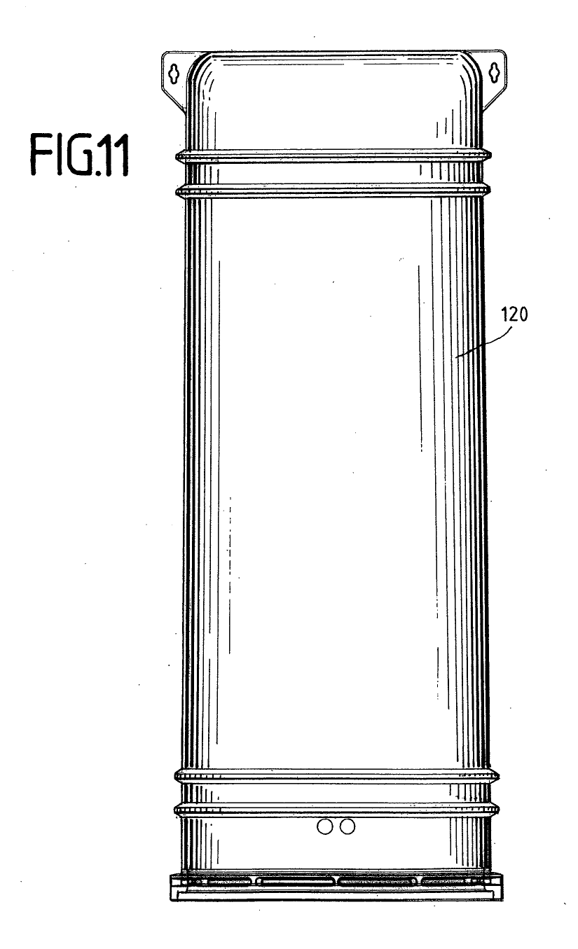

FIG. 10 shows a perspective view from below of the bundle core repository in the pivoted-up state, and

FIG. 11 shows a side view of a housing upper part.

FIG. 1 illustrates a sleeve 1 for optical waveguide cables 2 without a housing upper part 120 (see FIG. 11). The sleeve comprises a housing lower part 3, a console 4, a carrier system 5, a fiber management unit 6 and a bundle fiber repository 7. The housing lower part 3 is formed with openings 30 for optical waveguide cables 2, which are sealed off from moisture via sealing elements 35. In this case, the housing lower part 3 is designed to have two or more parts, lateral circumferential parts 32 of the housing lower part 3, including edge parts of the openings 30, being fixed detachably on a base plate 31, preferably by means of screws 33, which are screwed into a thread 34 of the base plate 31. Preferably, as many circumferential parts 32 are arranged detachably as openings 30 for optical waveguide cables 2 are provided, precisely one opening 30 being exposed laterally or radially by each circumferential part 32.

First, the manner in which the optical waveguide cables 2 are connected will be explained with reference to FIG. 2. The console 4 which consists of plastic has a star-shaped cross section and is formed on the lower side 41 with pedestal feet 42, which have holes 43. The console 4 can then be screwed to the housing lower part 3 by means of screws, which are not illustrated. The upper side 44 has a round central region, from which seven rests 45 protrude in the form of a star. A ground plate with holes 47, which are aligned with openings in the rests 45, is formed on the upper side 44. In each case one angled sheet-metal part 48, which has a desired bending point 49 in the form of a tapered portion, is screwed onto the ground plate 46. A fixing element 50 for fixing a central element 21 of the optical waveguide cable 2 is arranged on the angled sheet-metal part 48. The fixing element 50 comprises a jaw 51 with an indentation and a plate 52 which can be screwed. In the example illustrated, a connection of the optical waveguide cable 2 to ground is illustrated by a ground strip 53, which is screwed to the angled sheet-metal part 48 and the console 4. The ground strip 53 is in this case bent such that it bears against the optical waveguide cable 2 on the side opposite the angled sheet-metal part 48. A connection to ground in the case of optical waveguide cables 2 is usually used when said optical waveguide cables are formed with a metal foil as diffusion protection against moisture. For this purpose, the outer sheathing of the optical waveguide cable 2 is then partially removed and the metal foil exposed. Then, a scroll spring 54 is wound onto the exposed metal foil and the ground strip 53, which scroll spring 54 then presses the ground strip 53 in a sprung manner against the metal foil and therefore then connects them electrically to one another (which is not illustrated in FIG. 2). The ground strip 53 is then screwed to the angled sheet-metal part 48 and the ground plate 46, the ground connection then being guided outwards via a connection (not illustrated) to the screws 33 of the lower part 3. Furthermore, the angled sheet-metal part 48 and the optical waveguide cable 2 are connected mechanically to one another via a clip 55, with the result that the optical waveguide cable 2 is fixed mechanically. Furthermore, a plurality of bundle cores 22 are illustrated in FIG. 2 which are arranged around the central element 21. Bundle cores 22 comprise a plurality of fibers having a common sheathing. For reasons of clarity, the bundle cores 22 are in this case illustrated such that they are cut away, whereas they are actually guided upwards. Furthermore, a fixing limb 56 is illustrated, to which a central carrier 71 of the carrier system 5 is screwed. A defective housing lower part 3 can be replaced by means of the desired bending point 49 and the detachable circumferential parts 32 of the housing lower part 3 without optical waveguide connections in the sleeve 1 being separated. For this purpose, the circumferential parts 32 of the housing lower part 3 are detached where optical waveguide cables 2 are connected. Then, the optical waveguide cables 2 are bent away at an angle to the side via the desired bending point 49, and the defective housing lower part 3 is removed. A reverse procedure is correspondingly used for mounting a new housing lower part 3.

FIG. 3 illustrates a fiber guide 61 of the fiber management unit 6, which is hidden in FIG. 1 by a covering 62. As illustrated in FIG. 1, a fiber guide 61 is arranged on the front side V of the carrier system 5 and a fiber guide 61 is arranged on the rear side R of the carrier system 5. The fiber guide 61 comprises two coil formers 63 and a plurality of retainers 64. Guide webs 66, which form guides 67, 68, are arranged on a lower side 65, which faces the console 4. If it is now intended for individual fibers of a bundle core 22 to be connected to another optical waveguide cable 2, the bundle core is cut. The end of the bundle cores is fixed in the region 67 and 68 in a part not illustrated. The fibers, which are intended to be connected to another optical waveguide cable 2, are supplied via the guide 68 to one or more splicing cassettes 80, which are arranged above the fiber management unit 6 on the front side V and rear side R of the carrier system 5. In this case, both the incoming fiber and the outgoing fiber are guided in the guide 68. The remaining fibers of a bundle core 22, which are not intended to be connected to another optical waveguide cable 2, but are intended to be looped through, are guided into the guide 67. There, the necessary reserve length or splicing reserve is wound onto the coil formers 63, and then these fibers are guided out of the other guide 67 back to the optical waveguide cable 2. In the center, the fiber guide 61 has an opening 69, through which the fiber guide 61 can be screwed to the central carrier 71 of the carrier system 5.

FIG. 4 illustrates the rear side of the fiber guide 61, which bears against the carrier system 5. In this case, the fiber guide 61 has four stop edges 70, which stop against edges of the carrier system 5 and therefore prevent the fiber guide 61 from tipping.

FIG. 5 illustrates the fiber management unit 6 in a side view. The two fiber guides 61 for the front side V and the rear side R are screwed to the central carrier 71 of the carrier system 5, the stop edges 70 stopping against stop edges of two profiled carriers 72, which are connected to the central carrier 71, the rear profiled carrier 72 being hidden in the illustration. A lateral fiber guide 74, which allows for the fibers to jump laterally from the front side V to the rear side R of the sleeve 1 are arranged laterally on the upper side 73 of the fiber guides 61 for the front side V and the rear side R. The lateral fiber guide 74 can in this case be a separate component or else one half can in each case be connected integrally to the fiber guides 61 for the front side V and rear side R.

FIG. 6 illustrates a plan view of the sleeve 1 with the bundle core repository 7 removed. In this case, coverings 81 for the splicing cassettes 80 are illustrated. The profiled carriers 72 have a central plate-shaped region 82, which is adjoined by a U-shaped region 83. The other side is adjoined by a region 84, which is initially in the form of a V, in this case the limbs 85 running parallel and having inwardly pointing bent-back portions 86. The splicing cassettes 80 are pushed onto the profiled carriers 72 from above. Then, the covering 81 is pushed over the last, uppermost splicing cassette 80 and fixed via stoppers 87, which can be screwed. Bundle core guides 90 are inserted into the region 84 of the left-hand profiled carrier. For example, the lateral fiber guide 74 is inserted on the other profiled carrier 72.

The bundle core guide 90 comprises a central web 91, which splits an outer edge 92 into two guides 93, 94 (see FIG. 7). In this case, the outer edge 92 is formed at in each case one of the guides 93, 94 with a cut-free portion 99, with the result that the parts 95, 96 of the outer edge 92 are sprung. This makes it possible to insert the bundle cores 22 laterally. The bundle core guide 90 is formed with a shaft 97 as an extension of the central web 91, an arrow-shaped attachment 98 being arranged at the end of said shaft 97. If the bundle core guide 90 is then plugged into the profiled carrier 72, the arrow-shaped attachment 98 latches behind the bent-back portion 86 of the profiled carrier 72. Owing to the design with two guides 93, 94, a clearly separated split between the bundle core 22 being guided towards the bundle core repository 7 and the bundle core 22 being guided back can be achieved.

FIG. 8 illustrates the bundle core repository 7. The bundle core repository 7 has a substantially cylindrical shape, which is closed towards the top by a removable cover 100. Three sprung props 102 are cut free from the outer face 101, press in a sprung manner against the turned-over housing upper part 120 and therefore stabilize the bundle core repository 7. Furthermore, the bundle core repository 7 has an opening 103, beneath which a rounded-off portion 104 is arranged.

FIG. 9 illustrates the bundle core repository 7 without the cover 100. Retainers 105 are arranged on the inner sides of the outer face 101. Furthermore, a winding cylinder 106 is arranged centrally on a bottom face 107. The bundle cores 22 are guided by the bundle core guides 90 to the bundle core repository 7 and inserted through the opening 103, wound around the winding cylinder 106 and then guided out again through the opening 103. The bundle core repository 7 therefore makes it possible for reserve lengths of uncut bundle cores 22, which are only looped through the sleeve 1, to be deposited centrally in ordered fashion.

FIG. 10 illustrates the bundle core repository 7 in a pivoted-up state. For this purpose, the bundle core repository 7 can be pivoted through approximately 90° with respect to a lower part 109 via a pivot bearing 108. The lower part 109 is latched to the carrier system 5. The bundle core repository is formed with a latching hook 110 on the lower side, which latching hook 110 latches with the lower part 109 in the initial position (see FIG. 1). In the pivoted-up position, the bundle core repository 7 is held by a latched-in consoleing strut 111 and is propped against the lower part 109. The consoleing strut 111 dips into a reciprocal 112 in the initial position. By means of a plug-type rail 114, which is arranged on a lower side 113 of the lower part 109, the lower part 109 with the bundle core repository 7 can then be plugged onto the upper side of the carrier system 5, the plug-type rail 114 latching in between the two U-shaped regions 83 of the profiled carriers 72.

FIG. 11 illustrates a side view of a housing upper part 120, which is consoleed on the sleeve 1 from above and is connected to the housing lower part 3.

### LIST OF REFERENCE SYMBOLS

1 Sleeve
2 Optical waveguide cable
3 Housing lower part
4 Console
5 Carrier system
6 Fiber management unit
7 Bundle fiber repository
21 Central element
22 Bundle core
30 Opening
31 Base plate
32 Circumferential part
33 Screw
34 Thread
35 Sealing element
41 Lower side
42 Pedestal feet
43 Holes
44 Upper side
45 Rests
46 Ground plate
47 Holes
48 Angled sheet-metal part
49 Desired bending point
50 Fixing element
51 Jaw
52 Plate
53 Ground strip
54 Scroll spring
55 Clip
56 Fixing limb
61 Fiber guide front side/rear side
62 Covering
63 Coil former
64 Retainer
65 Lower side
66 Guide webs
67,68 Guides
69 Opening
70 Stop edges
71 Central carrier
72 Profiled carrier
73 Upper side
74 Lateral fiber guide
80 Splicing cassette
81 Coverings
82 Plate-shaped region
83 U-shaped region
84 V-shaped region
85 Limb
86 Bent-back portions
87 Stopper
90 Bundle core guides
61 Central web
92 Edge
93, 94 Guides
95, 96 Parts
97 Shaft
98 Arrow-shaped attachment
99 Cut-free portion
100 Cover
101 Outer face
102 Props
103 Opening
104 Rounded-off portion
105 Retainer
106 Winding cylinder
107 Bottom face
108 Pivot bearing
109 Lower part
110 Latching hook
111 Consoleing strut
112 Reciprocal
113 Lower side
114 Plug-type rail
120 Housing upper part
V Front side
R Rear side

1) A carrier system for a distribution device for optical waveguides for accommodating components for optical waveguides, in particular for accommodating splicing cassettes, wherein the carrier system comprises a central carrier, on whose sides in each case one profiled carrier is arranged, the profiled carriers having profiles for accommodating the components on the front side and/or rear side.

2) The carrier system as claimed in claim 1, wherein the profiled carriers have a region, which is initially in the form of a V, on the outwardly pointing sides, then limbs running parallel and having inwardly pointing bent-back portions.

3) The carrier system as claimed in claim 2, wherein the profiled carriers have a U-shaped region on the inwardly pointing sides.

4) The carrier system as claimed in claim 3, wherein a plate-shaped region is arranged between the V-shaped region and the U-shaped region.

5) The carrier system as claimed in claim 1, wherein the profiled carriers are a multiple longer than the central carrier.

6) The carrier system as claimed in claim 1, wherein transverse carriers are arranged between the profiled carriers.

7) The carrier system as claimed in claim 1, wherein the central carrier has at least one hole.
